(19) United States
(12) Patent Application Publication
(10) Pub. No.: US 2017/0223066 A1
(43) Pub. Date: Aug. 3, 2017

(54) DETECTING AND REPORTING CONTENT CAPTURE EVENTS DURING AN ONLINE CONFERENCE SESSION

(71) Applicant: Cisco Technology, Inc., San Jose, CA (US)

(72) Inventor: Theodore Robert Grevers, JR., Milford, MA (US)

(21) Appl. No.: 15/013,142

(22) Filed: Feb. 2, 2016

(51) Int. Cl. H04L 29/06; G06F 3/0484; G06F 3/0481

(52) U.S. Cl. CPC H04L 65/1083; G06F 3/04817; G06F 3/04842

(57) ABSTRACT

Detecting and reporting content capture (e.g., screen capture) events during an online conference session includes, at a server having connectivity to a network, during an online conference session involving a plurality of endpoints in which a first participant at a first endpoint is sharing content, detecting a content capture event initiated at a second endpoint during the online conference session. Identity information indicating an identity of a participant at the second endpoint and content information indicating the content that was captured during the content capture event is generated and the identity information and content information is made available to a computing device associated with the first participant.

### TECHNICAL FIELD The present disclosure relates to collaboration systems and, more particularly, to online conference systems.

### BACKGROUND

Online conference systems, sometimes referred to as video conference, web conference, teleconferencing, telepresence, or collaboration systems, allow meetings between persons or groups of people at different locations to communicate by at least simultaneous two-way content and audio transmissions. For example, online conference systems may allow participants in a session (e.g., a meeting) to converse audibly while sharing content, such as desktop content, application content (e.g., presentations) and/or other such materials during the session. In some instances, online conference systems may also allow two-way video transmissions.

Often, materials shared during a session include confidential information. In some instances, such as a one-on-one meeting between a manager and employee, all participants in a session may be authorized or have full access to presented confidential materials and, thus, there are no confidentiality issues. However, a presenter may still want to control access or ownership of presented materials and, thus, may not want session participants to take content captures (e.g., screenshots) of presented content. In other instances, such as a presentation to a large audience, some of the session participants (e.g., audience members) may be restricted from disclosing any confidential information shown during the presentation session (e.g., participants may be viewing confidential materials under a non-disclosure agreement). Consequently, in order to ensure the confidentiality of the materials, a presenter may not want participants to capture confidential content being presented (e.g., screenshots). Notably, many online conferencing systems include native screen capture capabilities and/or support screen capture functions native to a computer system on which the online conference system is being implemented.

### BRIEF DESCRIPTION OF THE DRAWINGS

FIG. 1 is a block diagram of an environment in which content capture processes are detected and reported during online conference sessions, according to an example embodiment.

FIG. 2A is a high-level flowchart illustrating a process for detecting and reporting, at a server application, content capture events during an online conference session, according to an example embodiment.

FIG. 2B is a flowchart illustrating a process for detecting, at a server application, content capture events during an online conference session, according to an example embodiment.

FIG. 3 is a high-level flowchart illustrating a process for detecting and reporting, at a client application, content capture events during an online conference session, according to an example embodiment.

FIG. 4 is a screenshot depicting an example user interface for a participant of an online conference session, according to an example embodiment.

FIGS. 5 and 6 are screenshots depicting example user interfaces for a presenting participant of an online conference session that are modified by reporting of a detected content capture event, according to example embodiments.

### DESCRIPTION OF EXAMPLE EMBODIMENTS

### Overview

Techniques are provided herein for detecting and reporting content capture (e.g., screen capture or screenshot) events during an online conference session. These techniques may be embodied as a method, a system, an apparatus, and instructions in a computer-readable storage media to perform the method.

According to at least one example embodiment, detecting and reporting content capture events during an online conference session includes, at a server having connectivity to a network, during an online conference session involving a plurality of endpoints in which a first participant at a first endpoint is sharing content, detecting a content capture event initiated at a second endpoint during the online conference session. Identity information indicating an identity of a participant at the second endpoint and content information indicating the content that was captured during the content capture event is generated and the identity information and content information is made available to a computing device associated with the first participant.

According to at least another example embodiment, detecting and reporting content capture events during an online conference session, includes, at a client application, detecting a content capture process during an online conference session. A content capture report including information regarding the content capture event is generated and transmitted to a server application in communication with the client application.

### Example Embodiments

Presented herein are techniques for detecting and reporting content capture events during an online conference session. The techniques presented herein may detect content capture events (such as screenshot, print-screen or other similar processes) included within online conference software (i.e., native to the online conferencing system), as well as non-native content capture processes, such as screen capture processes included on a computing device supporting the online conference system. Generally, a server application hosting the online conference session monitors client applications participating in the online conference session. Each client application may continuously monitor a computing device the client application is being executed on and the server application may continuously communicate with all of the client applications involved in the online conference session to detect a content capture event. However, the server application does not merely alert the presenter that a content capture event was initiated. Instead, a computing device associated with the presenting participant is notified, by the server application, which participant initiated a content capture event (e.g., the identity of the participant associated with an endpoint taking a screenshot) and what content was captured by the content capture event. Consequently, the presenter will know what confidential information may be at risk and who to approach to remedy the situation. This knowledge will enhance online conference systems by allowing users to share confidential information more securely and effectively.

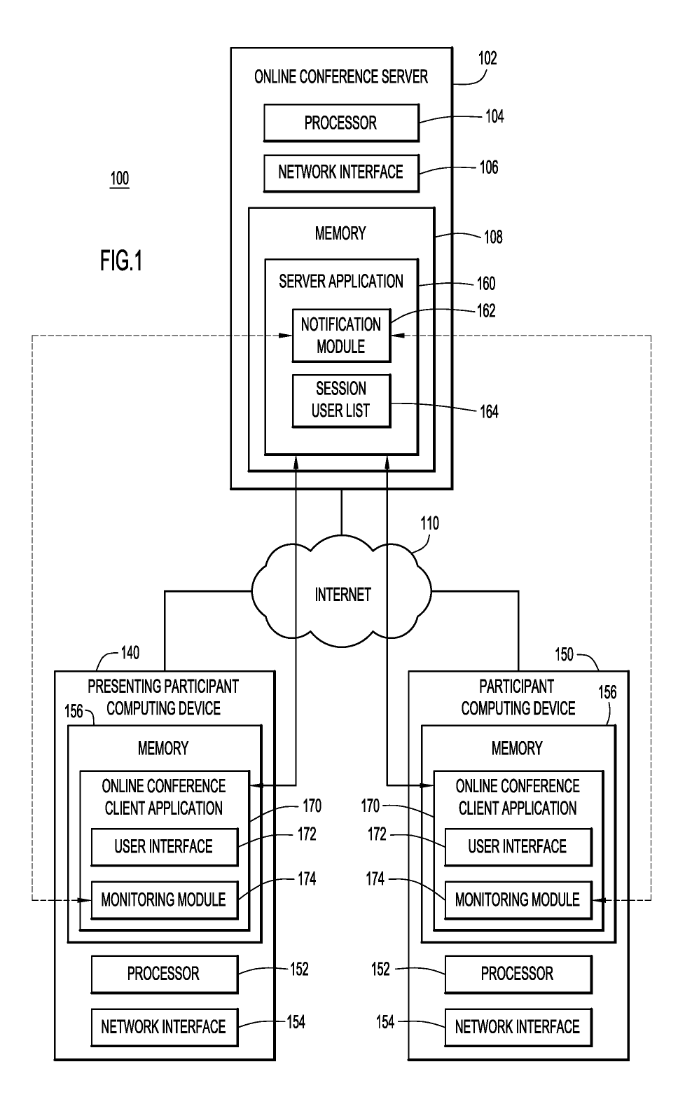

Reference is first made to FIG. 1, which illustrates a computing environment 100 for detecting and reporting content capture processes during an online conference session. In the computing environment 100, an online conference server 102 communicates, via the Internet 110, to a plurality of computing devices 120 (which may also be referred to as endpoints). For simplicity, the plurality of computing devices 120 is illustrated as including a presenting participant computing device 140 (presenting endpoint) and a participant computing device 150 (participant endpoint) in FIG. 1. However, in other embodiments, the plurality of computing devices 120 may include any number of computing devices. Moreover, one or more of the endpoints may be embodied entirely as one or more software applications running on a computing device, such as in a cloud or data center environment. Thus, an endpoint may be a physical device or a software process.

The online conference server 102 includes a processor 104, network interface 106, and a memory 108. The processor 104 is configured to execute instructions stored on memory 108 and the network interface 106 provides connectivity to the Internet 110. The online conference server 102 also includes a server application 160 that may reside on memory 108 and provide support for online conference client applications 170 (also referred to herein as client applications 170, for simplicity) that may be installed on the plurality of computing devices 120 (i.e., downloaded via the Internet 110). The server application 160 may include a notification module 162 and a session participant list 164. Generally, the server application 160 is configured to direct online conference traffic flows between any online conference client applications 170 participating in an online conference session (illustrated in solid lines). The session participant list 164 maintains a list of participants in a particular online conference session. Additionally, the notification module 162 of the server application 160 is configured to communicate with monitoring modules 174 the online conference client applications 170 during an online conference session in order to detect content capture events and alert a presenter to the detection (illustrated with dashed lines).

Each of the plurality of computing devices 120 (e.g., presenting participant computing device 140 and participant computing device 150) includes a processor 152 configured to execute instructions stored in a memory 156 and a network interface 154 that provides connectivity to the Internet 110. For example, the processor 152 may be configured to execute instructions to install the client application 170, which may include a user interface 172 and a monitor module 174. The user interface 172 may provide an interface for a participant (presenting or non-presenting) to view other participants participating in online conference session, as well as any content being shared or displayed during the online conference session. The monitoring module 174 may monitor the specific computing device it is executed on in order to detect the initiation of any content capture processes on that particular computing device. Consequently, for the purposes of detecting and reporting content capture events, when the server application 160 is described as communicating with an online conference client application 170, the notification module 174 may be communicating with the monitoring module 174.

Still referring to FIG. 1, each of the plurality of computing devices may be any computing device compatible to support the online conference client application 170. For example, computing device 140 may be a tablet computer and computing device 150 may be a smartphone, desktop, virtual machine, or any other device, provided that each of the plurality of computing devices includes a processor 152 configured to support the online conference client application 170 and network equipment 154 configured to provide connect the device to the Internet 110, respectively.

Additionally, although each module described herein, such as the notification module 162 and the monitoring module 174, is shown stored in memory 156 or memory 108, each module described herein, may be implemented hardware, or a combination of hardware and software. For example, each module may include and/or initiate execution of an application specific integrated circuit (ASIC), a Field Programmable Gate Array (FPGA), a circuit, a digital logic circuit, an analog circuit, a combination of discrete circuits, gates, or any other type of hardware, or combination thereof. Accordingly, as used herein, execution of a module by a processor can also refer to logic based-processing by the module that is initiated directly or indirectly by the processor to complete a process or obtain a result. Additionally or alternatively, each module can include memory hardware, such as at least a portion of a memory, for example, that includes instructions executable with a processor to implement one or more of the features of the module. When any one of the modules includes instructions stored in memory and executable with the processor, the module may or may not include a processor. In some examples, each module may include only memory storing instructions executable with the processor to implement the features of the corresponding module without the module including any other hardware.

Moreover, memory 108 and/or memory 156 may also be configured to store any messages, generated alerts, information related to alerts, user lists, instructions related to detecting a presenter, instructions related to detecting a content capture event, or any other data. Generally, memory 108 and/or memory 156 may include read only memory (ROM), random access memory (RAM), magnetic disk storage media devices, optical storage media devices, flash memory devices, electrical, optical or other physical/tangible (e.g., non-transitory) memory storage devices. Thus, in general, the memory 108 and/or memory 156 may be or include one or more tangible (non-transitory) computer readable storage media (e.g., a memory device) encoded with software comprising computer executable instructions. For example, memory 108 and/or memory 156 may store instructions that may be executed by processor 104 or processor 152, respectively, for performing the content capture process detection and reporting as described below with reference to the figures. In other words, memory 108 and/or memory 156 may include instructions, that when executed by one or more processors, cause the one or more processors to carry out the operations described below in connection with the figures.

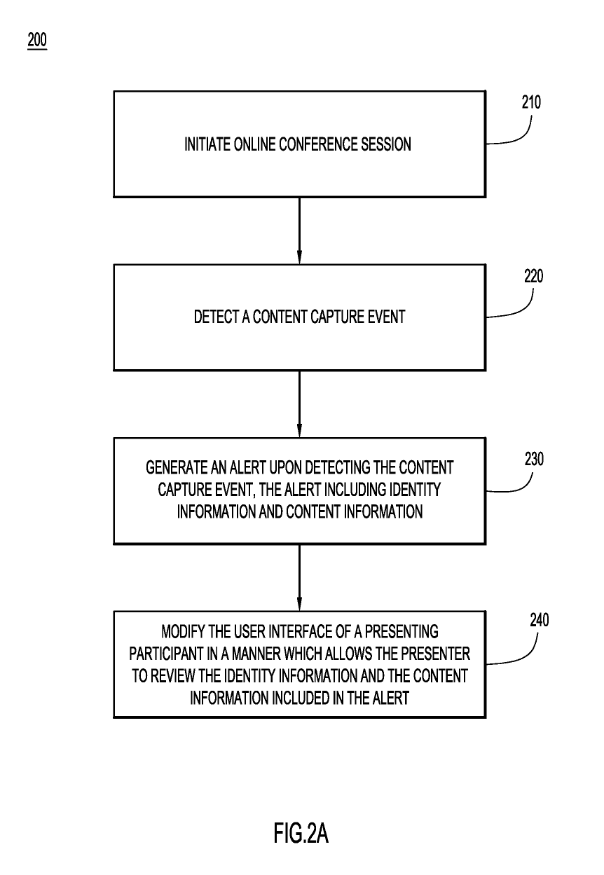

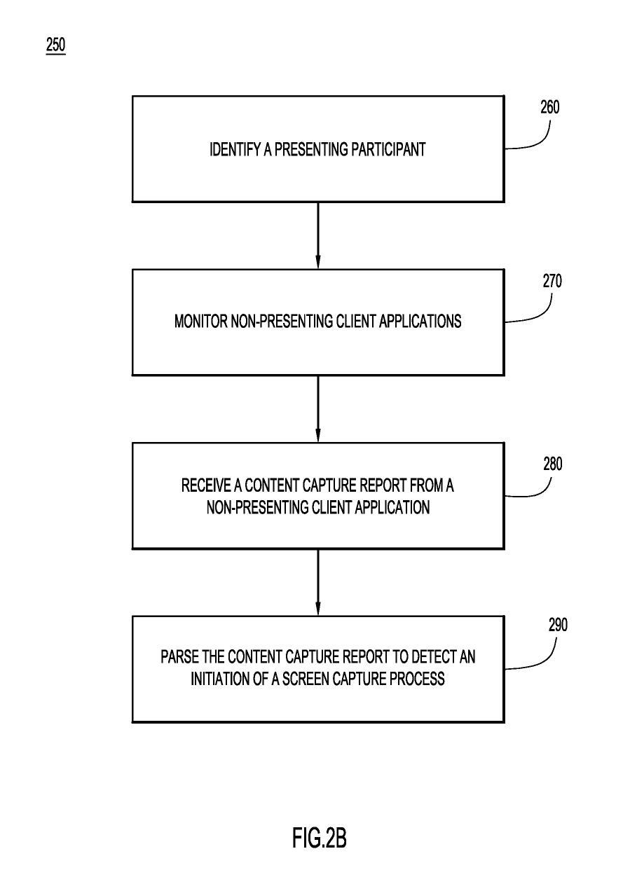

Reference is now made to FIG. 2A (with continued reference to FIG. 1) for a high-level description of a method 200 for detecting and reporting content capture events, such as performed by execution of the software instructions included in the memory 108. Initially, at step 210, an online conference session is initiated. The online conference session may include two or more participants participating from two or more computing devices. Once the session is initiated, each client application 170 is operatively connected to the server application 160 such that any client applications 170 connected to the session are in communication with each other in an online conference session via the server application 160. The session may be established using any suitable protocols now known or hereinafter developed. In some embodiments, upon establishing the online conference session, the server application may designate or assign one client application 170 as the leader or presenter. For example, the client application “hosting” the session may be designated as the presenter, at least initially. The server application 160 may also enable the presenter to share content that is accessible from his/her computing device and/or currently displayed on the display of their computing device. In some embodiments, the participants may choose to change the presenter (e.g., “pass the ball”) during the online conference session so that different participants may share content during different portions of the online conference session. In some embodiments, only the current presenter may select another participant to become the presenting participant.

At step 220, a content capture event is detected by monitoring the online conference session. More specifically, in at least some embodiments, the server application 160 monitors the client applications 170 when the server application 160 is launched and/or when an online conference session begins. Meanwhile, each of the client applications 170 monitor their respective computing devices for a content capture process when launched and/or when that client application 170 joins the conference session. In at least one embodiment, upon detecting a content capture process, the client application 170 generates a content capture report which can be parsed by the server application 160 in order to detect a content capture event. This embodiment is described in more detail below with respect to FIG. 2B.

Upon detecting a content capture event (e.g., receiving and analyzing a communication or report from a client application 170 to determine a content capture event was detected at a client application), the server application may generate an alert at step 230 to be transmitted to the client application of the computing device associated with the participant that was the presenting participant at the time the content capture event was detected. The alert includes at least an identity of the participant that initiated the content capture event (e.g., identity information), as well as information relating to the content that was captured with the content capture (e.g., what information was in a screenshot). Additionally or alternatively, the server application 160 may simply generate identity information indicating an identity of a participant at the second endpoint and content information indicating the content that was captured during the content capture event without generating an alert. In these embodiments, the identity information and content information may be made available to the presenting participant in any desirable manner. For example, the identity information and content information may be available in a report that is delivered, available for download, or otherwise available subsequent to or during the online conference session.

In some embodiments, the information relating to the content may be an image of the captured content (e.g., a copy of the screen shot taken). Additionally or alternatively, the information may indicate which slide of a slide show was showing when the content capture event occurred or any other desirable indication. As an example, consider a scenario where participant 1 is presenting a slideshow with slides A, B, and C in an online conference session including participants 1, 2, and 3. If participant 2 takes a screenshot of slide B, the server application 160 (and, in particular, notification module 162) will generate information indicating that participant 2 took a screenshot of slide B. The information may include a copy of the screenshot (e.g., a copy of the text and images included on slide B) or other identifying information, such as a page number, so that the presenting participant can identify the content was captured in the screenshot. In some embodiments, the information may also include or be associated with a timestamp indicating the time at which the content capture event occurred (e.g., a timestamp may be included on a copy of a screenshot). If included, the timestamp could be a time of day (e.g., presenter's local time), a time of the session (e.g., 5:42 into the online conference session), or any other desirable time designation enabling the presenter to see the time and/or time offset from the start of the online conference session at which the content capture event took place.

At step 240, the user interface 172 of the presenter's client application 170 is configured to allow the presenter to review the identity information and the content information included in the alert. Initially, the server application 160 identifies who the presenter was at the time the content capture event occurred. This may be accomplished via various techniques, including tracking the assignment of presenter, tracking a current speaker, or any other desirable process. Once the presenter at the time the content capture event occurred is identified, the user interface of the associated client application 170 is configured to provide an indication of the content which was captured in the content capture event and to provide an indication of the participant that initiated the content capture event.

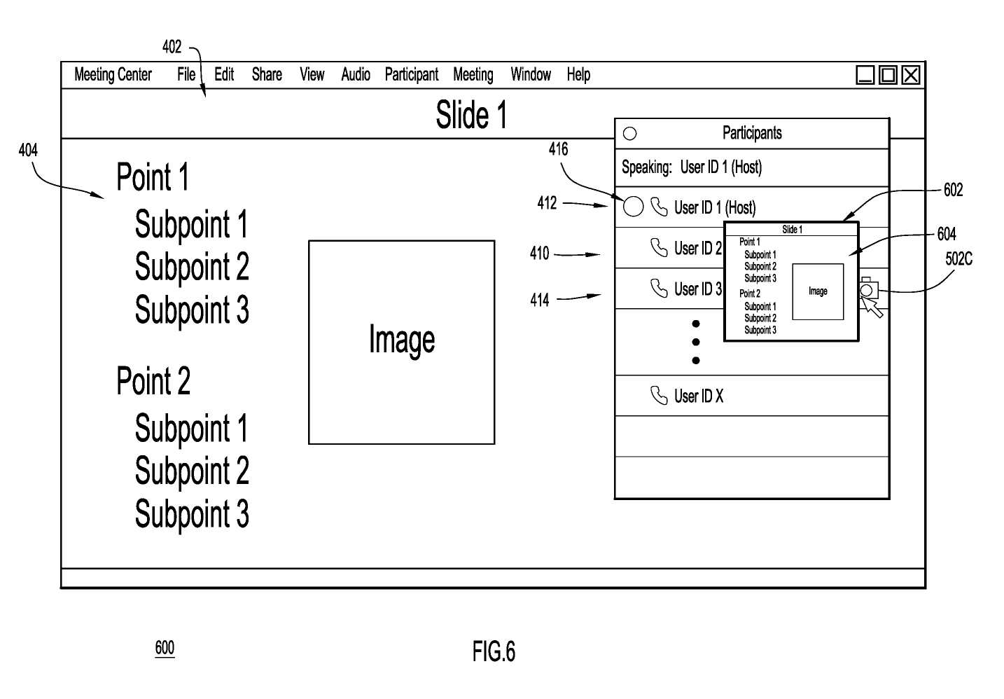

For example, if the user interface includes an attendees or participants list for the online conference session, an icon (e.g., a camera icon) may be placed next to the participant who is associated with the client application 170 where the content capture event was detected (e.g., the participant who took the screenshot). In some embodiments, the icon may be active, such that when clicked or selected additional information is displayed, such as the information indicating the content that was captured in the content capture event. An example icon is shown and described in further detail below with regards to FIG. 6. Additionally or alternatively, a notification box may appear in the user interface of the presenter, an alert may scroll across the presenter's user interface, and/or the name of the participant who took a screenshot may be modified to a different color, font, or location. In still other embodiments, any other modification may be made to the user interface of the participant who was presenting at the time of the content capture event in order to alert the presenter that content he or she was presenting was showing when a screenshot process was detected.

In summary, according to at least one example embodiment, detecting and reporting content capture events during an online conference session according to method 200 includes, at a server having connectivity to a network, during an online conference session involving a plurality of endpoints in which a first participant at a first endpoint is sharing content, detecting a content capture event initiated at a second endpoint during the online conference session. Identity information indicating an identity of a participant at the second endpoint and content information indicating the content that was captured during the content capture event is generated and the identity information and content information is made available to a computing device associated with the first participant.

As another example, in some embodiments, the content information and identity information may be stored at the server for the duration of the online conference session and presented to the presenting participant subsequent to the online conference session. More specifically, each time a content capture event is detected, content information and identity information may be associated with a time the content capture event occurred. Then, the content information, identity information, and the time may be stored in memory until this information is presented to the presenter. In some embodiments, a report may be generated when a presenter finishes presenting. Additionally or alternatively, a report may be generated after an online conference session concludes. In some embodiments, multiple reports may be generated for a single online conference session and be presented accordingly. For example, one report may be generated per presenter, and each report may include content capture event information (e.g., content information and identity information) from the time(s) during the online conference session that the participant was the presenter. Then, the reports may be presented to their respective presenters. Presenting the content information and identity information to presenters subsequent to an online conference session may reduce distractions during the online conference sessions and, thus, may be preferable in some situations (e.g., an important presentation to superiors). Additionally or alternatively, content information and identity information may be presented to a device other than the device the presenter is presenting from, either during the online conference session (e.g., at the time of the content capture event) or subsequent to the online conference session. For example, if a presenter is presenting from a desktop or laptop computer, content capture event information (e.g., identity information and content information) may be sent to a phone and/or tablet that is also known or determined to be associated with the presenter.

In some embodiments, the identity information and the content information is associated with a time of occurrence of the content capture event and stored with the time. In some of these embodiments, the identity information and the content information is presented to the computing device associated with the first participant after the online conference session is completed. The computing device referred to here may be the same as the first endpoint used by the first participant, or may be a different device to which the first participant has access. In other words, presenting the identity information and the content information associated with the detected screen capture event, after the conference session has completed, may occur on a device different from an endpoint that the first participant used for the participation in the online conference session.

Additionally or alternatively, the identity information and the content information may be presented at the first endpoint during the online conference session. In some of these embodiments, an icon is displayed, in association with a list of participants in the online conference, adjacent to the identity of the participant at the second endpoint, the icon being configured to display the content information. For example, in at least some embodiments, one or more images of the content information are displayed in response to a cursor roll over or selection of the icon.

In still other embodiments, detecting further includes receiving from the second endpoint a message indicating that the content capture event has occurred.

Reference is now made to FIG. 2B for a more detailed description of a method of detecting a screen content capture at server application 160. At step 260, an endpoint associated with a presenting participant is identified in any desirable manner, such as by querying an information table stored in the memory 108 that tracks which endpoint is currently designated as the presenter (or being used by a user designated as the presenter). Regardless of how an endpoint associated with the presenting participant is determined, determining the endpoint associated with the presenting participant enables the server application 160 to recognize which computing devices need to be monitored in order to detect a content capture event. Then, as each client application 170 monitors active processes running on its respective computing device for a content capture event, the server application 160 monitors the non-presenting client applications at step 270 until the server application 160 requests and/or receives content capture reports from the appropriate client applications 170 at step 280. More specifically, the notification module 162 of the server application may receive reports from the monitoring module 174 of the client applications. In some embodiments, the server application 160 constantly monitors reports at steps 270 and 280. However, in other embodiments, the server application 160 monitors the client applications to determine when a content capture report has been generated and only receives content capture reports when a client application detects a content capture event. In other words, in some embodiments, client applications 170 only generate content capture reports when a content capture event is detected.

At step 280, the server application 160 (e.g., the notification module 162) parses the one or more received content capture reports to detect the presence of a content capture event. In particular, the server application identifies the particular client application 170 sending the report and correlates the identity of the client application with a participant identity included in the session participant list 164 maintained by the server application 160. Additionally, the notification module 162 of the server application 160 extracts information indicating content that was captured (e.g., screen capture event information) from the content capture report generated by the monitoring module 174 of the client application 170.

Notably, during the steps performed in methods 200 and 250, a non-presenting session participant may be unaware of the content capture event detection. In other words, the detection process may be completely transparent. Consequently, a participant initiating a content capture event (e.g., taking a screens shot) may not be aware that the presenter is aware of their use of a content capture process.

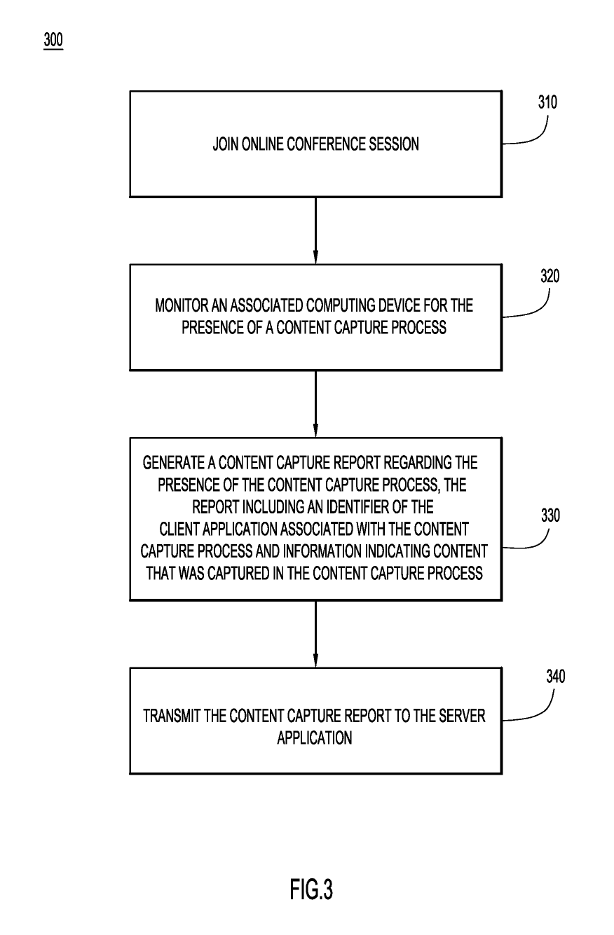

Now reference is made to FIG. 3 (with continued reference to FIG. 1) for a high-level description of a method 300 for detecting screen capture processes at a client application 170, such as performed by execution of the software instructions included in the memory 156 of a computing device of the plurality of computing devices 120. Initially, at step 310 the client application 170 joins an online conference session via the server application 160 through any desirable collaboration protocol.

At step 320, the client application 170 monitors its associated computing device for the presence of a content capture event (e.g., the initiation of a screen capture process), such as via the monitoring module 174. In some embodiments, the monitoring module 174 begins to monitor its associated computing device upon launch of the client application 170; however, in other embodiments, the monitoring module 174 begins monitoring its associated computing device when the client application 170 joins an online conference session. Regardless, the monitoring module 174 may continue to monitor its associated computing device for a content capture event (e.g., initiation of a screen capture process) any time the client application 170 is connected or participating in an online conference session. In some embodiments, the monitoring module 174 terminates when the web client application terminates.

Depending on the client device's operating system, different methods exist for the detection of a content capture process. A content capture process running on the computing device indicates the occurrence of, or at least the initiation of, a content capture event. Consequently a detected process may indicate a content capture event or an attempted content capture event. As an example, for APPLE Operating System (OS) X, the client application 170 monitors for the presence of a screen capture process launched from the /usr/sbin/screencapture application. However, in other embodiments, the client application may monitor a variety of operating systems, such as WINDOWS, LINUX, ANDROID or APPLE iOS for screen capture processes with similar operating system detection methods. Moreover, as content capture technologies evolve across existing and new client platforms, the client application 170 may continue to identify content capture processes as they are executed at a session participant's computing device. Moreover, the monitoring module may detect any screen capture processes included the client application 170 (e.g., content capture processes native to the client application 170). Consequently, the monitoring module 174 may detect both native and non-native content capture processes in order to detect a content capture event occurring on a computing device.

At step 330, a content capture report (e.g., a message) is generated to notify the server application 160 of the presence of a detected content capture event. The message includes at least an identifier that indicates the client application 170 that is detecting the content capture event and the content that was captured in the content capture event. In some embodiments, the message may also include the identity of a user associated with the client application 170. Then, at step 340, the message is transmitted to the server application 160. For example, when a content capture event is observed to be running by a client application 170, the client application 170 reports its identifier (ID) and the occurrence of a content capture event to the server application 160 apparatus via an Extensible Messaging and Presence Protocol (XMPP) encapsulated message. The XMPP message may be secured via Transport Layer Security (TLS). However, XMPP is only used as an example and, in other embodiments, any other client to server communication protocol, such as Hypertext Transfer Protocol (HTTP), HTTP-Secure (HTTPS), may be utilized. XMPP is simply used as an example because it easily allows a central server to scale to hundreds or even thousands of clients.

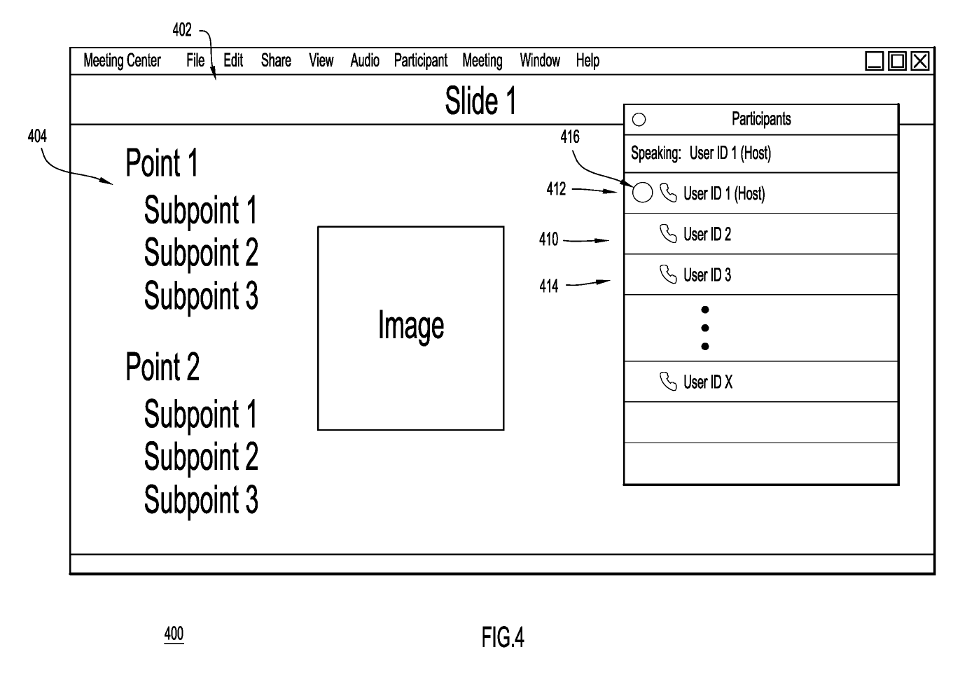

Now referring to FIGS. 4-6 for a description of the example screenshots 400, 500, and 600 of user interfaces provided by client applications 170. As is described in further detail below, screenshot 400 illustrates an unmodified user interface and, thus, screenshot 400 may be representative of both a presenting participant's user interface and a non-presenting participant's user interface. By comparison, screenshots 500 and 600 illustrate modified user interfaces that are only relevant to the presenter's user interface.

In FIG. 4, a screenshot 400 of a user interface 402 is shown during an online conference session. The majority of the user interface 402 displays content 404 that is being presented by a presenter, including any text, images, documents, etc. For example, in FIGS. 4-6, the content 404 includes a presentation slide with text and an image. Additionally, the user interface 402 includes a list of participants 410. The list of participants 410 may be populated by the session participant list 164 maintained by the server application 160 and may include any number of participants. In some embodiments, the list of participants 410 may include icons next to each participant to indicate whether the participant is participating with only an audio feed, an online and audio feed, is muted, etc. Additionally, the list of participants 410 may include a presenter icon 416 to indicate which participant is currently acting as and/or designated as the presenter. For example, in FIGS. 4-6, User ID 1 is shown at 412 to be the presenter (the presenter icon 416 is adjacent this participant's name). By comparison, at 414, User ID 3 is not presenting and, thus, does not include a presenter icon 416.

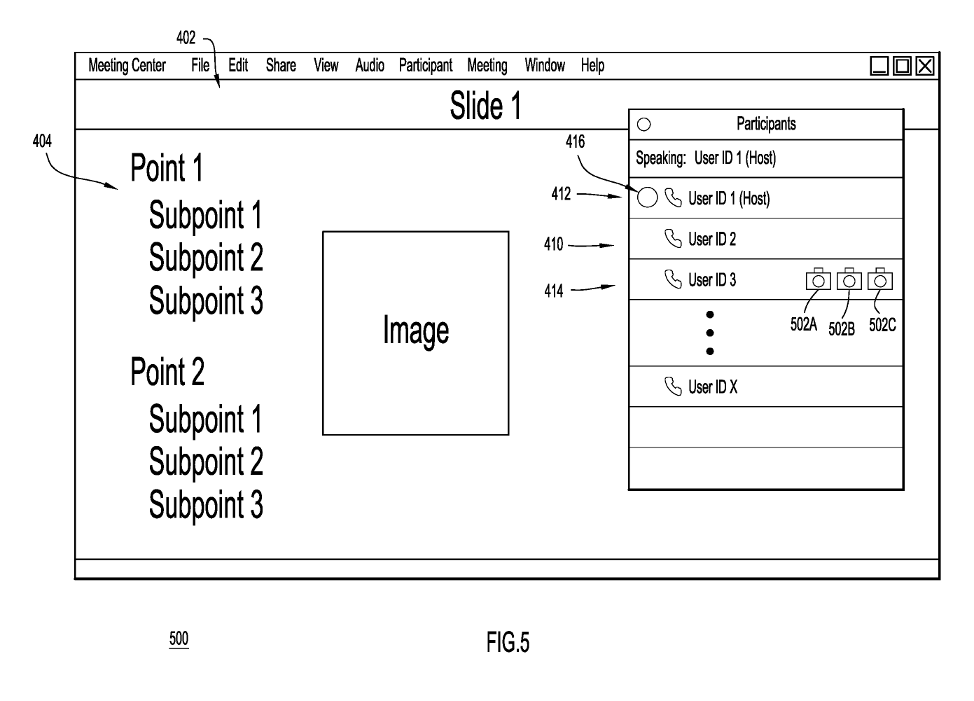

In FIGS. 5 and 6, screenshots 500 and 600 both illustrate a user interface 402 that has been modified in view of an alert generated by the server application 160. Screenshot 500 illustrates a presenter's user interface subsequent to User ID 3 taking three screenshots of the presenter's content. Thus, icon 502A, icon 502B, and icon 502C now appear next to User ID 3 in the participants list 410. Each of the icons (502A, 502B, and 502C) represents a different content capture event that occurred during this presenter's presentation. Moreover, in this embodiment, the icons are active/actuatable icons and thus, upon actuation (selection by clicking or mouse hovering), each icon may reveal further information relating to the particular screenshot it represents. For example, the presenter could either roll over an icon or click on an icon in order to see images of one of the screenshots that were taken by User ID 3. In some embodiments, the images of the screenshots may also each include their own time stamp.

FIG. 6 illustrates one example embodiment of the additional information that may be provided when an actuatable icon is actuated. In FIG. 6, icon 502C is shown once actuated. When actuated (e.g., hovered over or clicked), the user interface 402 is modified to show an insert that includes the content information that was captured in the screenshot taken by a participant (in this case, User ID 3). As mentioned, in some embodiments, the information may simply be a description of the content that was shown at the time (e.g., slide 3/10 in presentation A); however, in the depicted embodiment, the insert 602 includes an image 604 of the screenshot that was taken by User ID 3. As mentioned, since only the presenter's user interface is modified in response to an alert being generated in response to the detection of a screen capture event, the icons 502A, 502B, 502C are only visible to the presenter of an online conference session. Thus, in screenshots 500 and 600, the camera icons, as well as the details of each screen capture provided in the insert 602 are only visible on the user interface of the presenter.

There are several advantages to the techniques presented herein. As one example, detecting screenshot processes during an online conference event alerts a presenter when participants may be taking screen captures of a presenter's content without the presenter's consent and/or improbably taking confidential information. Consequently, the techniques presented herein may help resolve leaks of confidential information and help individuals or businesses determine which clients or colleagues may be trustworthy partners. Moreover, since the techniques presented herein alert a presenter that confidential information has been improperly taken, a presenter may take action before the leak spreads beyond this instance. The techniques presented herein will be particularly useful for individuals or businesses that want to protect intellectual property and may provide these individuals or businesses with a sense of security that allows them to share confidential information during online conferences, instead of trying to describe the confidential information with only calls or emails.

To summarize, in one form, a method is provided comprising: at a server having connectivity to a network, during an online conference session involving a plurality of endpoints in which a first participant at a first endpoint is sharing content, detecting a content capture event initiated at a second endpoint during the online conference session; and generating identity information indicating an identity of a participant at the second endpoint and content information indicating the content that was captured during the content capture event, wherein the identity information and content information is made available to a computing device associated with the first participant.

In another form, an apparatus is provided comprising: a network interface unit configured to enable network connectivity; a processor coupled to the network interface unit, wherein the processor is configured to: at a server having connectivity to a network, during an online conference session involving a plurality of endpoints in which a first participant at a first endpoint is sharing content, detect a content capture event initiated at a second endpoint during an online conference session involving a plurality of endpoints in which a first participant at a first endpoint is sharing content; and generate identity information indicating an identity of a participant at the second endpoint and content information indicating the content that was captured during the content capture event, wherein the identity information and content information is made available to a computing device associated with the first participant.

In yet another form, a non-transitory computer-readable storage media is provided encoded with software comprising computer executable instructions and when the software is executed operable to: detect a content capture event initiated at a second endpoint during an online conference session involving a plurality of endpoints in which a first participant at a first endpoint is sharing content; and generate identity information indicating an identity of a participant at the second endpoint and content information indicating the content that was captured during the content capture event, wherein the identity information and content information is made available to a computing device associated with the first participant.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
at a server having connectivity to a network, during an online conference session involving a plurality of endpoints in which a first participant at a first endpoint is sharing content, detecting a content capture event initiated at a second endpoint during the online conference session; and
generating identity information indicating an identity of a participant at the second endpoint and content information indicating the content that was captured during the content capture event, wherein the identity information and content information is made available to a computing device associated with the first participant.

2. The method of claim 1, further comprising:
associating the identity information and the content information with a time of occurrence of the content capture event; and
storing the identity information and the content information with the time.

3. The method of claim 2, further comprising:
presenting the identity information and the content information to the computing device associated with the first participant after the online conference session is completed.

4. The method of claim 1, further comprising:
presenting the identity information and the content information at the first endpoint during the online conference session.

5. The method of claim 4, wherein presenting further comprises:
displaying, in association with a list of participants in the online conference session, an icon adjacent to the identity of the participant at the second endpoint, the icon being configured to display the content information.

6. The method of claim 5, further comprising:
displaying one or more images of the content information in response to a cursor roll over or selection of the icon.

7. The method of claim 1, wherein detecting further comprises:
receiving from the second endpoint a message indicating that the content capture event has occurred.

8. An apparatus comprising:
a network interface unit configured to enable network connectivity;
a processor coupled to the network interface unit, wherein the processor is configured to:
detect a content capture event initiated at a second endpoint during an online conference session involving a plurality of endpoints in which a first participant at a first endpoint is sharing content; and
generate identity information indicating an identity of a participant at the second endpoint and content information indicating the content that was captured during the content capture event, wherein the identity information and content information is made available to a computing device associated with the first participant.

9. The apparatus of claim 8, wherein the processor is further configured to:
associate the identity information and the content information with a time of occurrence of the content capture event; and
store the identity information and the content information with the time.

10. The apparatus of claim 9, wherein the processor is further configured to:
present the identity information and the content information to the computing device associated with the first participant after the online conference session is completed.

11. The apparatus of claim 8, wherein the processor is further configured to:
present the identity information and the content information at the first endpoint during the online conference session.

12. The apparatus of claim 8, wherein in presenting, the processor is further configured to:
display, in association with a list of participants in the online conference session, an icon adjacent to the identity of the participant at the second endpoint, the icon being configured to display the content information.

13. The apparatus of claim 12, wherein the processor is further configured to:
display one or more images of the content information in response to a cursor roll over or selection of the icon.

14. The apparatus of claim 8, wherein in detecting, the processor is further configured to:
receive from the second endpoint a message indicating that the content capture event has occurred.

15. A non-transitory computer-readable storage media encoded with software comprising computer executable instructions and when the software is executed operable to:
detect a content capture event initiated at a second endpoint during an online conference session involving a plurality of endpoints in which a first participant at a first endpoint is sharing content; and
generate identity information indicating an identity of a participant at the second endpoint and content information indicating the content that was captured during the content capture event, wherein the identity information and content information is made available to a computing device associated with the first participant.

16. The non-transitory computer-readable storage media of claim 15, further comprising instructions operable to:
associate the identity information and the content information with a time of occurrence of the content capture event; and
store the identity information and the content information with the time.

17. The non-transitory computer-readable storage media of claim 16, further comprising instructions operable to:
present the identity information and the content information to the computing device associated with the first participant after the online conference session is completed.

18. The non-transitory computer-readable storage media of claim 15, further comprising instructions operable to:
present the identity information and the content information at the first endpoint during the online conference session.

19. The non-transitory computer-readable storage media of claim 15, wherein the instructions operable to present further comprise instructions operable to:
display, in association with a list of participants in the online conference session, an icon adjacent to the identity of the participant at the second endpoint, the icon being configured to display the content information in response to a cursor roll over or selection of the icon.

20. The non-transitory computer-readable storage media of claim 15, wherein the instructions operable to detect further comprise instructions operable to:
receive from the second endpoint a message indicating that the content capture event has occurred.
